(19) United States
(12) Patent Application Publication
(10) Pub. No.: US 2008/0106056 A1
(43) Pub. Date: May 8, 2008

(54) Heat shrunken low-friction stabilizer bar sleeve

(75) Inventor: Mark Allen Kleckner, Roseville, MI (US)

Correspondence Address: CARLSON, GASKEY & OLDS, P.C., 400 WEST MAPLE ROAD, SUITE 350, BIRMINGHAM, MI, 48009, US

(73) Assignee: Meritor Suspension Systems Company, U.S.

(21) Appl. No.: 11/593,844

(22) Filed: Nov. 7, 2006

(51) Int. Cl. B60G 21/055

(52) U.S. Cl. 280/124.107

(57) ABSTRACT

A stabilizer bar for a vehicle suspension includes a sleeve that is heat shrunk around the stabilizer bar. The sleeve is made from a low-friction polymer or thermoplastic material and is first installed on the stabilizer bar in a pre-shrunken state. Heat is subsequently applied to the sleeve to shrink and fix the sleeve to the stabilizer bar. A bushing is then mounted on the sleeve.

### TECHNICAL FIELD

The subject invention relates to a stabilizer bar having a heat-shrunk sleeve for mounting a bushing.

### BACKGROUND OF THE INVENTION

Bushings are used to isolate and mount a stabilizer bar to a vehicle structure, such as a vehicle frame, and to allow rotation of the stabilizer bar. One type of bushing is comprised of a resilient sleeve made from a material such as rubber, for example. The bushing typically includes additional structure that is used to reduce friction between the stabilizer bar and the bushing. This structure is molded, attached, or impregnated into the bushing.

In one known configuration, the bushing includes a Teflon® “sock-type” liner that is molded over, bonded, or adhered to an inner surface of the resilient sleeve of the bushing. These types of liners are expensive in terms of material and processing costs. The cost is further increased as a result of overmold tooling, which is used to secure the liner to the bushing.

In another known configuration, a low-friction agent, commonly referred to as “Slippery Rubber,” is incorporated into the rubber. It is not desirable to utilize this type of agent because the material is expensive. Further, this material has proven to have noise issues in certain applications.

Thus, there is a need for a more cost-effective mounting configuration for bushings on a stabilizer bar that overcomes the deficiencies discussed in the prior art above.

### SUMMARY OF THE INVENTION

A stabilizer bar for a vehicle suspension includes a sleeve that is heat shrunk around the stabilizer bar. A bushing is then mounted on the sleeve. As such, relative rotation may occur between the bushing and sleeve instead of between the sleeve and the stabilizer bar. This can increase wear life of the bushing and provides a more cost-effective mounting solution.

In one example, the sleeve is made from a low-friction polymer or thermoplastic material and is first installed on the stabilizer bar in a pre-shrunken state. Heat is subsequently applied to the sleeve to shrink and fix the sleeve to the stabilizer bar. The bushing is subsequently mounted over the sleeve.

In one example, the sleeve has a longer axial length than the bushing to ensure adequate coverage should “walking” occur. “Walking” is a condition where the stabilizer bar moves in an axial direction relative to the bushing bar.

These and other features of the present invention can be best understood from the following specification and drawings, the following of which is a brief description.

### BRIEF DESCRIPTION OF THE DRAWINGS

FIG. 1 is a schematic view of a stabilizer bar incorporating the subject invention.

FIG. 2A is a side view shown in partial cross-section of a stabilizer bar and a sleeve in a pre-shrunken state.

FIG. 2B is a side view shown in partial cross-section of the stabilizer bar and the sleeve in a shrunken state.

FIG. 3 is a cross-sectional view taken along line 3-3 as indicated in FIG. 2.

FIG. 4 is a cross-sectional view of another example of a stabilizer bar incorporating the subject invention.

FIG. 5 is a cross-sectional view of another example of a stabilizer bar incorporating the subject invention.

FIG. 6 is a cross-sectional view of another example of a stabilizer bar incorporating the subject invention.

FIG. 7 is a cross-sectional view of another example of a stabilizer bar incorporating the subject invention.

### DETAILED DESCRIPTION OF THE PREFERRED EMBODIMENT

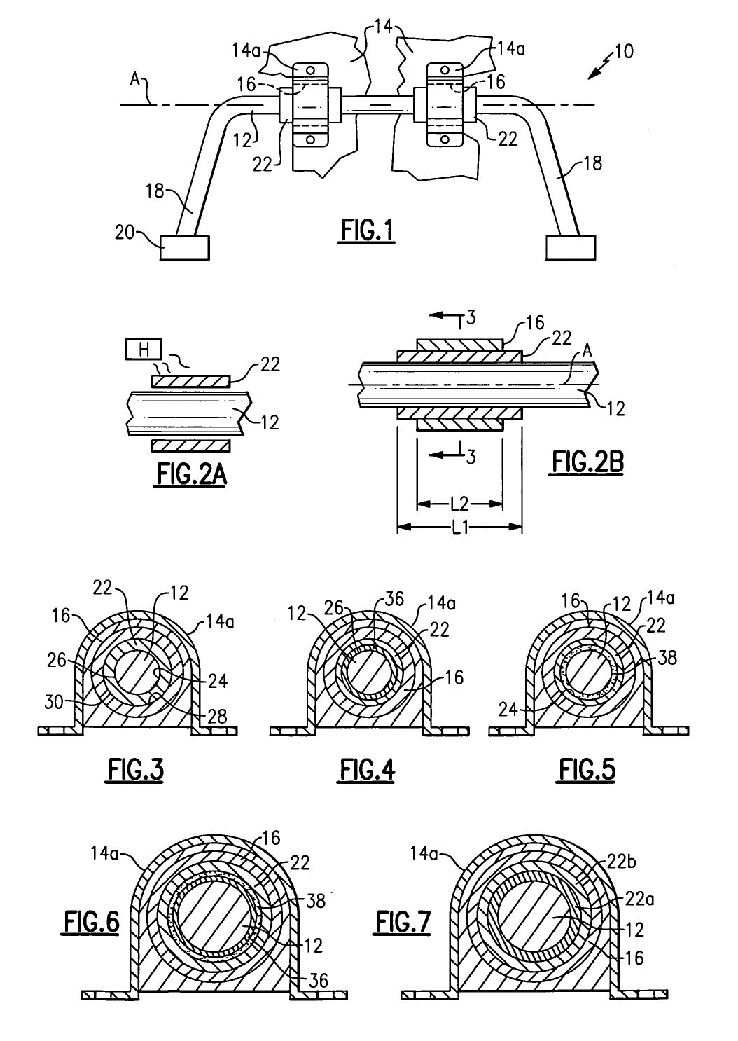

A suspension assembly 10, shown in FIG. 1, includes a stabilizer bar 12 that is securable to a vehicle structure 14 with bushings 16. A bracket 14a is used to mount the bushings 16 to the vehicle structure 14. Two bushings are shown, however, a single bushing or a greater number of bushings could also be utilized for certain applications. The stabilizer bar 12 includes opposing ends 18 that are securable to laterally opposed suspension components 20, such as left hand and right hand control arms, for example. It should be understood that while the stabilizer bar 12 is generally shown to have a C-shape configuration, the stabilizer bar 12 may include bends and/or angle portions depending upon the desired suspension configuration and vehicle application.

A sleeve 22 is heat-shrunk onto the stabilizer bar 12 prior to installation of the bushing 16. In the example shown, each bushing 16 includes a separate sleeve 22, however, a single sleeve could be used to mount multiple bushings. The sleeve 22 has a pre-shrunken state (FIG. 2A) and a shrunken state (FIG. 2B). In the pre-shrunken state, the sleeve 22 has a larger diameter than when in the shrunken state. When in the pre-shrunken state, the sleeve 22 can easily be fit over the stabilizer bar 12, and can be properly positioned in a desired location for receiving the bushing 16.

Once in the proper location, the sleeve 22 is shrunk onto the stabilizer bar 12 by a brief application of heat via a heat source H. The heat source H can be a heat gun or a heat lamp, for example. The sleeve 22 comprises a tube of material such as polytetrafluoroethylene (PTFE), TetraFluorEthylene-Prefluorpropylene (FEP), or other similar low-friction polymer or thermoplastic, for example. A typical working temperature for this type of material is 350 degrees Fahrenheit.

Once the sleeve 22 achieves the shrunken state, the sleeve 22 is fixed to the stabilizer bar 12 such that there is no relative rotation between the sleeve 22 and stabilizer bar 12. In this configuration, as shown in FIG. 3, an inner surface 24 of the sleeve 22 directly engages an outer surface 26 of the stabilizer bar 12. Next, the bushing 16 is installed over the sleeve 22 such that an inner surface 28 of the bushing 16 directly engages an outer surface 30 of the sleeve 22. The bushing 16 is made from resilient material such as rubber, for example, however other types of material could also be used.

In this configuration, relative rotation may occur between a rubber-type component, i.e. the bushing 16, and a plastic-type component, i.e. the sleeve 22. This configuration improves fatigue life, reduces cost, and decreases noise when compared to traditional configurations where relative rotation occurred between the rubber-type component, i.e. the bushing, and a metal component, i.e. the stabilizer bar.

As shown in FIG. 1, at least a portion of the stabilizer bar 12 extends in a lateral direction along a lateral axis A. The sleeve 22 has a first axial length L1 that extends generally along the lateral axis A. The bushing 16 has as second axial length L2 that extends generally along the lateral axis A. The first axial length L1 is greater than the second axial length L2 (FIG. 2B) to ensure adequate coverage for stabilizer bar “walking.” “Walking” occurs when the stabilizer bar 12 moves axially relative to the bushings 16.

In one example embodiment, the sleeve 22 is installed on the stabilizer bar after the stabilizer bar 12 has been painted, see FIG. 4. In this example, the stabilizer bar 12 includes a layer of paint 36 that is applied to the outer surface 26 of the stabilizer bar. The sleeve 22 is then installed after painting at an assembly bench before the bushings 16 are installed. Thus, assembly and tooling is significantly simplified when compared to traditional configurations.

In one example embodiment, a layer of adhesive 38 is applied to the inner surface 24 of the sleeve 22, see FIG. 5. This will ensure that there is a tight seal to the stabilizer bar 12 to keep out any moisture or debris. Optionally, a layer of paint 36 and a layer of adhesive 38 could both be used as shown in FIG. 6.

The subject invention of heat shrinking sleeves 22 onto a stabilizer bar 12 could also be used to eliminate extra part numbers and extra tooling. Typical heat shrink tubing (used to form the sleeve 22) is available in 0.020 inches or 0.5 mm wall thickness. This would add 1 mm diameter to the stabilizer bar 12 when attached.

It is common to have stabilizer bars with diameters that are very close to each other, such as 1 mm diameter apart from each other, for example. With the present invention, two (2) sleeves 22 can be used instead of a single sleeve 22 to accommodate the 1 mm difference in diameter.

Thus, as shown in FIG. 7, a first sleeve 22a would be heat shrunk on the stabilizer bar 12, and a second sleeve 22b would be heat shrunk over the first sleeve 22a. The bushing 16 would then be installed around the second sleeve 22b. A layer of paint 36 (FIG. 4) and/or a layer of adhesive 38 (FIG. 5) could also be used with this configuration.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A stabilizer bar assembly comprising:
a stabilizer bar;
a sleeve having a heat-shrunken body that is fixed to said stabilizer bar such that there is no relative rotation between said sleeve and said stabilizer bar; and
a bushing fitted over said sleeve.

2. The stabilizer bar assembly according to claim 1 wherein said sleeve includes a pre-shrunken state and a shrunken state comprising said heat-shrunken body, said sleeve changing from said pre-shrunken state to said shrunken state after said sleeve is assembled onto said stabilizer bar.

3. The stabilizer bar assembly according to claim 1 including a layer of paint between an inner surface of said sleeve and an outer surface of said stabilizer bar.

4. The stabilizer bar assembly according to claim 1 including a layer of adhesive between an inner surface of said sleeve and an outer surface of said stabilizer bar.

5. The stabilizer bar assembly according to claim 1 wherein at least a portion of said stabilizer bar extends along a lateral axis, and wherein said sleeve has a first axial length extending generally along said lateral axis and said bushing has a second axial length extending generally along said lateral axis, said second axial length being less than said first axial length.

6. The stabilizer bar assembly according to claim 1 wherein said sleeve is comprised of one of a low-friction polymer material and thermoplastic material.

7. The stabilizer bar assembly according to claim 1 wherein said sleeve is comprised of one of a PTFE material and a FEP material.

8. The stabilizer bar assembly according to claim 1 wherein said bushing is comprised of a resilient material that directly engages an outer surface of said sleeve.

9. The stabilizer bar assembly according to claim 1 wherein said stabilizer bar has opposing arm ends that are adapted for mounting to vehicle suspension components.

10. The stabilizer bar assembly according to claim 1 wherein said bushing is mountable to a vehicle structure.

11. The stabilizer bar assembly according to claim 1 wherein said sleeve comprises a first sleeve and including a second sleeve that has a heat-shrunken body that is fixed to said first sleeve with an inner surface of said bushing directly engaging an outer surface of said second sleeve.

12. A method of mounting a bushing to a stabilizer bar comprising:
(a) providing a stabilizer bar;
(b) heat shrinking a sleeve around the stabilizer bar; and
(c) mounting a bushing around the sleeve.

13. The method according to claim 12 wherein the sleeve has a pre-shrunken state and a shrunken state, and including fitting the sleeve over the stabilizer bar in the pre-shrunken state and subsequently applying heat to the sleeve to achieve the shrunken state where the sleeve is fixed to the stabilizer bar such that there is no relative rotation between the sleeve and the stabilizer bar.

14. The method according to claim 12 including applying a layer of paint to the stabilizer bar prior to step (b).

15. The method according to claim 12 including applying adhesive to an inner surface of the sleeve prior to step (b).

16. The method according to claim 12 including forming the sleeve from one of a low-friction polymer material and a thermoplastic material.

17. The method according to claim 12 including forming the bushing from a resilient material.

18. The method according to claim 12 including forming the sleeve from a plastic material and forming the bushing from a resilient material, directly engaging an inner surface of the sleeve against an outer surface of the stabilizer bar, and directly engaging an inner surface of the bushing against an outer surface of the sleeve.

19. The method according to claim 12 wherein the sleeve comprises a first sleeve and including the steps of heat shrinking a second sleeve over the first sleeve and mounting the bushing around the second sleeve.
